(19) United States
(12) Patent Application Publication
(10) Pub. No.: US 2016/0171181 A1
(43) Pub. Date: Jun. 16, 2016

(54) SYSTEM AND METHOD FOR ASSESSING SUBJECT EVENT RATE REPORTING

(71) Applicant: Medidata Solutions, Inc., New York, NY (US)

(72) Inventors: Stephen Young, Glenmoore, PA (US); Mladen Laudanovic, New York, NY (US); Anson Kring, Royersford, PA (US)

(21) Appl. No.: 14/565,607

(22) Filed: Dec. 10, 2014

(51) Int. Cl. G06F 19/00; G06Q 50/22

(52) U.S. Cl. CPC G06F 19/363; G06Q 50/22

(57) ABSTRACT

A system for assessing a clinical trial site's subject event reporting rate includes a subject event and visit count processor and a site subject event rate processor. The subject event and visit count processor receives subject event and subject visit data from a plurality of clinical trial sites and calculates for each clinical trial site a total visit count and a total subject event count. The site subject event rate processor receives the total visit count and total subject event count for each clinical trial site, calculates a trial-level subject event rate for the clinical trial, calculates for each clinical trial site an expected total subject event count based on the clinical trial site's total visit count and the trial-level subject event rate, and compares for each clinical trial site the expected total subject event count to the total subject event count to assess the probability that the clinical trial site is under-reporting or over-reporting subject events.

### BACKGROUND

Clinical trials (sometimes called “clinical studies”) are often used to assess the safety and efficacy of a drug or a medical device. In some trials, hundreds or thousands of test sites enroll thousands or tens of thousands of patients or subjects.

It is very expensive to monitor all of the test sites to ensure compliance with a clinical trial protocol. In the past, site monitors would visit each site on a frequent basis to manually review all of the subject records to ensure compliance. More recently, centralized site monitoring has emerged in which site monitors remotely examine different metrics related to various aspects of site quality and performance to look for sites that are statistical outliers and thus in need of closer inspection. Examples of a method and apparatus for remote site monitoring are disclosed in U.S. Pat. No. 8,706,537, assigned to the same Applicant and assignee, Medidata Solutions, Inc., and is hereby incorporated by reference in its entirety.

One metric that may be monitored during a clinical trial is the occurrence of subject events, which comprise anything that may happen to a clinical trial subject that is not specifically prescribed by the clinical trial protocol and that would be of clinical interest to report. One type of subject event is an adverse event, sometimes abbreviated “AE.” An AE typically includes any event that is observed to occur to a subject during his/her participation in the trial that may have a negative impact on health or well-being, and may include headache, stomachache, dry mouth, high blood pressure, fast heart rate, migraines, seizures, stroke, heart attack, etc. Other types of subject events may include concomitant medications—the use of one or more medications other than the medication under investigation—while a subject participates in a clinical trial; and disease-specific events, such as the number of times a clinical trial subject wakes up in the middle of the night due to a specific disease or condition.

One way of measuring site compliance with subject event (“SE”) reporting is by examining the subject event rate, which has been calculated as (Total Count of Subject Events)/(Total Count of Subjects), and comparing that to a clinical trial benchmark. But that subject event rate calculation is too simplistic and in many situations does not do a good job of identifying clinical sites that may have subject event reporting problems.

### BRIEF DESCRIPTION OF THE DRAWINGS

FIG. 1A is a graph showing AE Rate vs. Subject Participation Time in days for a particular clinical trial;

FIG. 1B is a graph showing AE Rate vs. Subject Participation Time in visits for a particular clinical trial;

FIGS. 2A and 2B are block diagrams of systems including a subject event and visit count processor and a site subject event rate assessor, according to embodiments of the present invention;

FIGS. 3A-3C are flowcharts illustrating the operation of a system that calculates subject event counts and subject visits for a site, according to an embodiment of the present invention;

FIG. 4 illustrates a block diagram of the subject event and visit count processor of FIG. 2B, according to an embodiment of the present invention;

FIG. 5A is a flowchart illustrating the operation of a system that calculates Trial SE Rate, according to an embodiment of the present invention;

FIG. 5B is a flowchart illustrating the operation of a system that calculates Trial Visit N SE Rate, according to an embodiment of the present invention;

FIG. 6 is a flowchart illustrating the operation of a system that assesses whether a site has a subject event reporting problem, according to an embodiment of the present invention; and

FIG. 7 provides an illustrative example of how a site's actual AE count is assessed against its expected count using a Poisson probability distribution.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Embodiments of the present invention may be used with respect to clinical trials, but the invention is not limited to such embodiments. In monitoring the subject event rates or adverse event rates for a clinical trial, one goal is to detect sites that are under-reporting or over-reporting subject events relative to some nominal expectation or benchmark (e.g., overall trial rate). Three criteria that may be used to evaluate how well any given method is at achieving this goal include:
1. Is the assessment method reliable; i.e., what is the likelihood the method will misrepresent the actual/true rate of subject event reporting at any given site?
2. Is the assessment method consistent; i.e., will the method result in a fair comparison between the subject event rate at any given site and the trial benchmark (or expectation) to which the rate is being compared?
3. Is the assessment method pro-active; i.e., will the method alert trial teams as early as possible to potentially problematic sites with respect to rate of subject event reporting?

Although this specification covers subject event reporting, in several places, for simplicity and because those of skill in the art are more familiar with the term “AE rate,” the term “adverse event” or “AE” may be used in certain contexts rather than “subject event,” knowing that the term “subject event” can easily be substituted.

As mentioned above, subject event rate may be a simple ratio:

$$SE Rate = \frac{Total Count of SEs}{Total Count of Subjects} \qquad ( 1 )$$

This simple ratio, however, does not take into account relative subject participation time at each site. In other words, at any given time during a trial, the amount of time each subject has participated in the trial will vary significantly. This variation is driven primarily by two factors. First, subjects begin participation in the trial at different times. The span of time over which all subjects begin trial participation is generally referred to as the “trial enrollment window,” which may last for many months. Second, some subjects will exit the trial prior to full/successful completion, limiting their total participation time by varying amounts depending on when they exited.

Subjects who have been participating in a given trial longer than other subjects—and who have been exposed to the investigational product (e.g., drug or medical device being investigated) and trial procedures longer—presumably also have had greater opportunity for SEs to occur. Thus if one site in the trial enrolled its subjects earlier than most other sites in the trial, one would expect the rate of SEs reported per subject to be significantly higher for this earlier-enrolling site than for other sites across the trial, and an assessment based on this rate would unfairly flag this earlier-enrolling site as exhibiting an elevated risk for over-reporting of SEs. Equation (1) for SE Rate therefore may not be a reliable or consistent measure.

Equation (1) may be improved by re-defining the denominator in the SE rate to account for total subject participation time. For example:

$$SE Rate = \frac{Total Count of SEs}{Total Subject Participation Time Across All Subjects} \qquad ( 2 )$$

The units of this rate may be expressed as SEs per unit time, e.g., per subject day or subject year. This definition is a form of normalization that provides more reliability and consistency of SE rate assessment across sites in a trial. However, the expected rate of SEs per subject may not be uniform over the period of each subject's participation. For example, the number of SEs reported for a given subject during months 0 through 6 of the subject's participation may differ from those reported during months 7 through 12. This variation in SE rates may depend on factors such as investigational product exposure, frequency of subject visits, and frequency/intensity of trial procedures, to name a few.

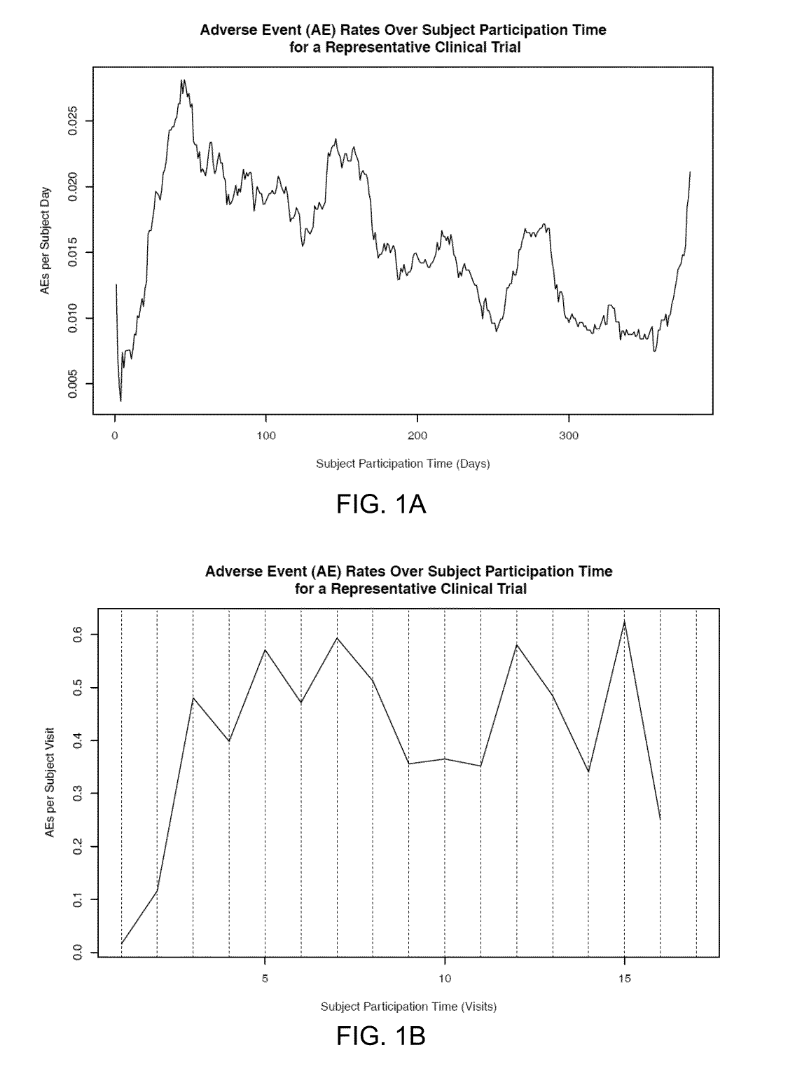

The inventors have analyzed the progression of AE rates per subject over participation time on a number of clinical trials stored in a database. The graph in FIG. 1A shows AE Rate vs. Subject Participation Time in terms of days. (To smooth out the graph a bit, the x-axis uses a 30-day moving average.) This graph is representative of the variability in AE rate (and SE rate, by extension) over subject participation time observed across numerous trials, and confirms the expectation that the rate is not uniform—nor even close to uniform—over time.

As a result of this variability in expected SE rates over time, the SE rate for a site with more recently enrolled subjects will likely be very different from the rate for a site with longer-participating subjects, and may be unfairly flagged for under- or over-reporting if the average participation time of that site's subjects differs from most of the other sites in the trial.

The inventors then realized that they could model different discrete phases of subject participation time, one example of which is the subject visits defined in a protocol's expected visit calendar (i.e., protocol schedule of events) for a particular trial. They analyzed the progression of SE rates over subject participation time with the addition of subject visit dates. It was observed that in this context, SE rates consistently trended lower between subject visits, and trended higher when closer in time to each subject visit. This was a consistent trend across many trials, and one possible interpretation of this result is that subjects are relatively less likely to report their SEs to sites when not in regular contact with the sites, but will report the SEs they remember when visiting the site and being explicitly solicited by site staff to report their SEs. The subject's recent memory is often better, which results in a higher level of reporting of SEs that have occurred closer in time to the visit (e.g., most recent week or two). Another factor may be the impact of intrusive procedures and/or investigational product administration typically performed at each subject visit, leading to an increase in reported SEs during or immediately following each subject visit.

Based on this analysis, the rate of SE reporting is more closely related to the volume of subject visits, and not simply the total subject participation time. Thus a further improvement can be made to the definition of SE Rate in Equation (2) as follows:

$$SE Rate = \frac{Total Count of SEs}{Total Count of Subject Visits} \qquad ( 3 )$$

This form of normalization uses a more relevant measure of subject participation cadence with respect to SE reporting (vs. simple calendar time), which yields a more reliable assessment of true SE (or AE) rate. The graph in FIG. 1B shows an improved AE Rate vs. Subject Participation Time, but now it is in terms of visits rather than days.

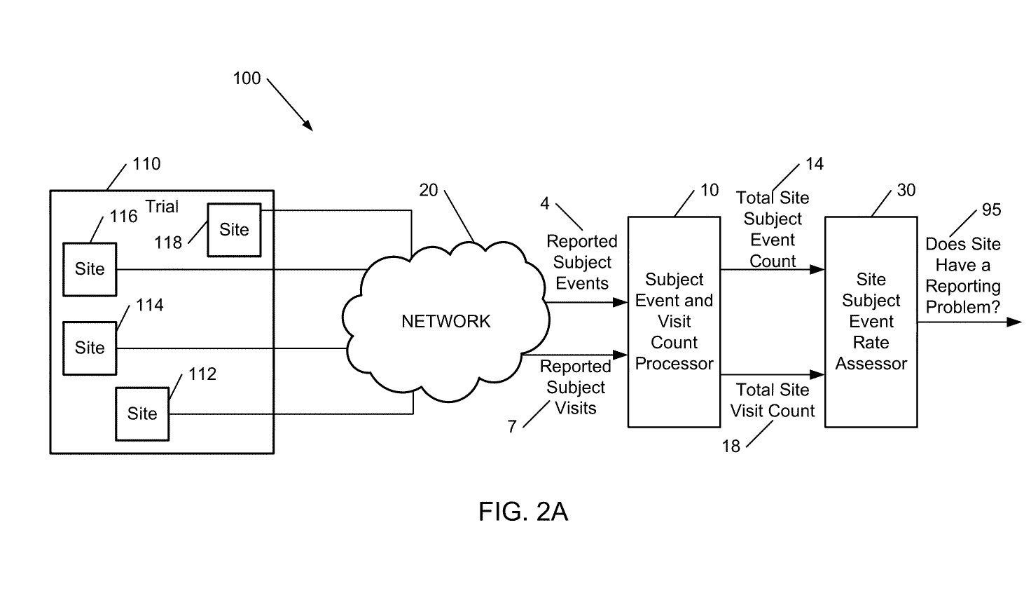

Reference is now made to FIG. 2A, which is a block diagram of a system 100 including a Subject Event and Visit Count Processor and a Site Subject Event Rate Assessor, according to an embodiment of the present invention. System 100 may include a number of sites generating data and transferring such data to network 20 and then to subject event and visit count processor 10. Sites 112, 114, 116, and 118 within a trial 110 generate the data and may be located in one or more geographic locations. While four sites are illustrated in FIG. 2A, the present invention contemplates the use of any number of sites within a trial. Network 20 may be any type of communications network, including a public or private telephone (e.g., cellular, public switched, etc.) network and/or a computer network, such as a LAN (local area network), a WAN (wide area network), or the Internet or an intranet, that enables subject event and visit count processor 10 to interact with the sites in order to send and/or receive data and other information. The connections between the sites and network 20 may be wired or wireless connections or even a file transfer system, such as a CD, DVD, or thumb or flash drive, which contains data from the sites. Subject event and visit count processor 10 and site subject event rate assessor 30 may be embodied on any type of computing program or application residing on any type of computing device, including but not limited to a personal, laptop, tablet, or mainframe computer, a mobile phone, or a personal digital assistant (PDA).

The data may be associated with a clinical trial for a drug or medical device. Subject event and visit count processor 10 may calculate total site subject event count 14 and total site visit count 18 for each site based on data received and reported from that site, including reported subject events 4 and reported subject visits 7. Then, using site subject event rate assessor (or processor) 30, trial-level subject event rates are computed and then used to derive an expected total site subject event count for each site, which is then used to determine whether the particular site's total site subject event count 14 is in line with the expected total site subject event count or whether there is a reporting problem 95.

Calculating a trial-level subject event rate may be performed by dividing the sum of the total site subject event counts for all sites by the sum of the total site visit counts for all sites. Calculating an expected total site subject event count may be performed by multiplying total site visit count 18 by the trial-level subject event rate.

In certain scenarios, such as when the system expects a certain amount of data by a specific visit but has not received such data, there may be a weighted visit count for each reported visit, which represents an estimated proportion of all required visit data that have already been reported for the subject for the given reported visit. For example, each patient may have six data forms for six different assessments for a visit in week 4. This sets up an expectation that there will be six forms for each patient. If the system receives only three forms, then the data actually received would be weighted as 0.5 or 50%.

Going beyond Equation (3), the inventors made a further observation that there is a distinct SE rate “footprint” that can be associated with each subject visit in any given trial. In particular, the overall rate of SEs observed for Visit 1 across all sites and subjects is unique and different from the overall rate of SEs observed for Visit 2, Visit 3, etc. The primary reason for this may have to do with the timing/cadence of investigational product administration—variable by visit—and the impact that has on subject well-being. Another factor may be the relative intrusiveness of other procedures administered to the subject that also vary across visits.

Thus SE Rate may be most effectively measured and assessed on a distinct subject visit basis. The specific approach taken by the inventors involves the following steps:
1. Compute for each site the SE count (“Site Visit N SE Count”) and Visit count (“Site Visit N Count”) for each distinct subject visit (“distinct visit,” e.g., Visit N) in the trial protocol's expected visit calendar;
2. Compute the SE rate for each distinct visit for the trial overall (“trial-level rate”), based on the counts computed for each site in the trial;
3. Using the trial-level rates for each distinct visit as the expected/nominal rate for each site, compute an expected SE count for each site for each distinct visit, based on the count of subjects that have completed each distinct visit at the site;
4. Compute a total expected SE count for each site as the sum of the expected SE counts for each distinct visit; and
5. Compute the probability (e.g., p-score) that each site's actual SE count would naturally deviate from the site's expected count by the amount observed. Probabilities that fall below a specified threshold value; e.g., 5% or 10%, will be flagged as an elevated (or high) risk.

Reference is now made to FIG. 2B, which is a block diagram of a system 150 that is similar to system 100 shown in FIG. 2A, but also includes an expected visit calendar 3 and determines whether there is a reporting problem 95 by counting subject events per each visit or visit N. System 150 may include the same sites generating data in trial 110 and transferring such data to network 20 and then to subject event and visit count processor 50. As will be described in more detail below, subject event and visit count processor 50 may calculate total site SE count 15, site visit N SE count 13, and site visit N count 17 for each site based on expected visit calendar 3 and data received and reported from that site, including reported SEs 5 and reported subject visits 7. Using site subject event rate assessor (or processor) 60, trial-level SE rates for each distinct visit N are used to derive an expected total site SE count across all distinct visit Ns, which is then used to determine whether the particular site's total site SE count 15 is in line with the expected total site SE count or whether there is a reporting problem 95. As with subject event and visit count processor 10 and site subject event rate assessor 30, subject event and visit count processor 50 and site subject event rate assessor 60 may be embodied on any type of computing program or application residing on any type of computing device, including but not limited to a personal, laptop, tablet, or mainframe computer, a mobile phone, or a personal digital assistant (PDA).

### Calculating Site SE Rate Per Visit

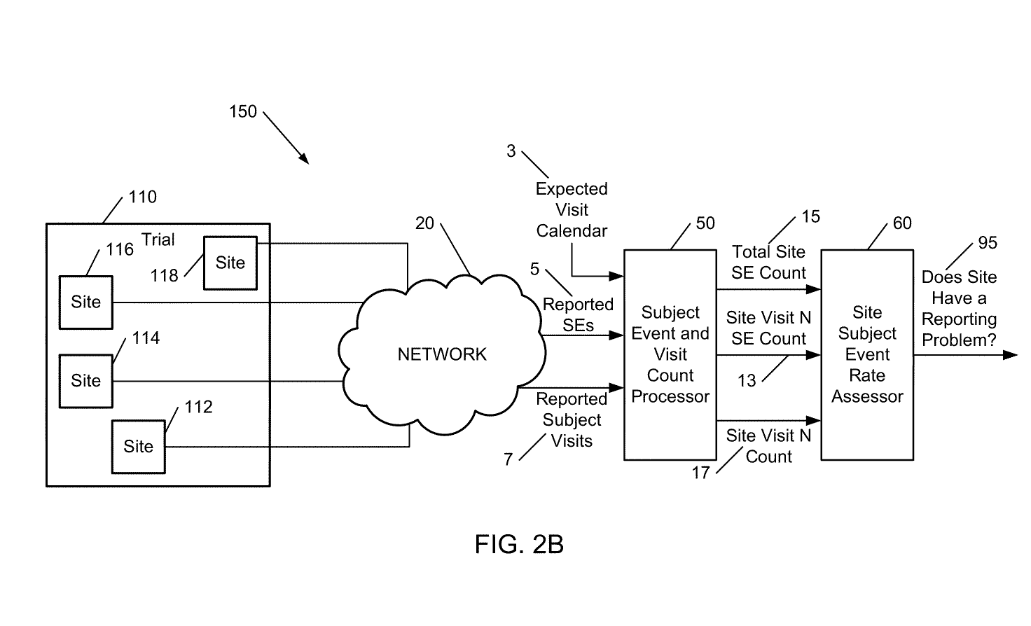

Reference is now made to FIGS. 3A-3C, which are flowcharts illustrating the operation of a system that calculates SE rate for a site for each distinct Visit N, according to an embodiment of the present invention. In FIG. 3A, for each site and for each distinct visit (Visit N), operation 301 calculates Site Visit N Count, which is a weighted sum of subjects having a Visit N, and operation 302 determines Site Visit N SE Count, which is the total count of SEs associated with Visit N at the site. FIG. 3B shows operations used to calculate Site Visit N Count 17 in operation 301, and FIG. 3C shows operations used to calculate Site Visit N SE Count 13 in operation 302 as well as Total Site SE Count 15, which is the total count of SEs reported across all subjects at the site.

Site Visit N Count: The Site Visit N Count is a weighted sum of subjects at a given site for whom a given distinct visit (e.g., Visit N) has been reported. FIG. 3B shows operation 340—calculate Site Visit N Count—which requires the results of operation 325, calculate Effective Visit N Date, operation 330, determine Final Effective Visit Date, and operation 335, determine a Weighted Visit N Count. Site Visit N Count is computed using the pseudo-code shown in Equations (4) and (5). Equation (4) calculates an Effective Visit N Date (operation 325) for each subject, which may be the actual visit date, if a valid Visit N Date exists, or the expected visit date based on the subject's expected visit calendar 3. Note that a Visit N date may be considered valid if it represents a real calendar date (e.g., February 31st is NOT valid), is not a future date, and is not out of chronological sequence with the given subject's other visit dates. Equation (4) also determines whether each subject's Visit N date represents the Final Effective Visit Date for that subject (operation 330). Both of these pieces of information—Effective Visit N Date and Final Effective Visit Date—are used in Equation (5) in computing the Site Visit N Count.

For each subject at the site:
For each distinct visit (e.g., Visit N) in the expected visit calendar:

$$If a valid Subject Visit Date exists for Visit N , then \\ Set Effective Visit N Date = the actual Visit N date for the subject \\ Otherwise \text{:} \\ Set Effective Visit N Date = the expected visit date per the {subject}^{′} s expected visit calendar . \\ If the Subject has exited the trial ( e . g . , Screen Failed , Early Terminated , or Completed ) , then \text{:} \\ If Effective Visit N Date is the most recent effective visit date for the subject \leq subject ’ s trial exit date , then \text{:} \\ Set Final Effective Visit Date = Effective Visit N Date ; \\ Otherwise if Effective Visit N Date > TODAY and this is the earliest effective visit date for the subject following TODAY , then \text{:} \\ Set Final Effective Visit Date = Effective Visit N Date \\ End of Visit Loop \\ End of Subject Loop \qquad ( 4 )$$

Equation (5) calculates Site Visit N Count (operation 340) using Effective Visit N Date and Final Effective Visit Date:

For each distinct visit (e.g., Visit N) in the expected visit calendar:

$$Initialize Site Visit N Count = 0 \\ For each subject at the site \text{:} \\ If \geq 70 \% of the expected eCRF forms for Visit N have been submitted , then \text{:} \\ Set Site Visit N Count = Site Visit N Count + 1 ; \\ Otherwise if Effective Visit N Date \leq Final Effective Visit Date , then \text{:} \\ If Effective Visit N Date \leq TODAY , then \text{:} \\ Set Site Visit N Count = Site Visit N Count + 0.5 \\ Otherwise \text{:} \\ Set Site Visit N Count = Site Visit N Count + [ \frac{0.5 * ( TODAY - Effective Visit N - 1 Date )}{( \begin{matrix}Effective Visit N Date - \\ Effective Visit N - 1 Date\end{matrix} )} ] \\ End of subject loop \\ End of Visit loop \qquad ( 5 )$$

The purpose of assessing in Equation (5) whether greater than 70% of expected eCRF visit forms for Visit N have been submitted is to determine through estimation whether the site has already reported any observed SEs associated with Visit N. If the site has not yet reported a clear majority of the expected Visit N data, we assume that entry is still in progress and therefore expect less than a full representation of SEs for the visit. In this case Visit N for the given subject will not be counted as an entire completed visit, and will instead be evaluated to determine whether it warrants partial or “weighted” counting. Thus, a weighted visit N count is determined for each subject (operation 335). Note that for the purpose of this invention, thresholds other than 70% of the expected visit data may be considered, as well as other methods to estimate the completion of SE reporting for a given subject visit.

Subject visits that cannot be counted fully (e.g., because less than 70% of expected visit data has been reported) may be evaluated to determine whether they warrant partial counting. In particular, if the Effective Visit N Date is in the past, it is counted as one-half (0.5) of a visit (the constant 0.5 is near the end of Equation (5)). If the Effective Visit N Date is in the future and is the next visit scheduled to occur for the subject, it is counted less than one-half (0.5), based on the elapsed duration from the subject's previous visit until TODAY (the day the calculation is being performed) as a proportion of the total duration from the subject's previous visit until the next scheduled visit. The rationale for this weighting (as represented in Equation (5)) is based on an estimate that the volume of SEs reported between visits is typically half of the total observed volume once the next visit occurs and all SEs have been reported. Note that a value different from one-half (0.5) may be used based on further industry analysis of the timing of SE reporting between visits. This constant may also be actively computed or derived during a trial by measuring the percentage of SEs that are reported on or following subject visit dates as compared to being reported prior to the subject visit date (e.g., using an audit timestamp for entry of SE records by the site).

It is also possible to set the above constant higher than the average estimated rate of SE reporting between visits, based on the knowledge that subject under-reporting of SEs between visits reflects an undesired site behavior, i.e., sites should be doing everything possible to get their subjects to actively report SEs that are occurring in between their scheduled on-site visits. Setting this constant higher sets a higher “expectation” of inter-visit SE reporting and may tend to more quickly expose those sites that are not complying with that expectation.

Other embodiments are possible that do not include an expected visit calendar. In some instances, we may know visit dates for visit 1 and visit 3 may be known, but not the date of visit 2. With an expected visit calendar, visit 2 could be added in and SEs could be slotted to it; without an expected visit calendar, visit 2 may not be modeled at all—all the SEs after visit 1 may instead be associated with visit 3.

Site Visit N SE Count and SE Visit Slotting: The Site Visit N SE Count is the count of SEs across all subjects at the site that have been associated with—or “slotted” to—Visit N. The method of slotting SEs to subject visits is detailed as follows.

To calculate Site Visit N SE Count in operation 302, the system assigns (or slots) SEs across all subjects at a given site to a subject visit (Visit N) in the protocol visit schedule. This SE Visit Slotting operation is depicted in operation 355 in FIG. 3C. The system first determines whether a given SE's Onset Date is valid. An SE Onset Date will be considered valid if it is a real calendar date (e.g., February 31st is NOT valid) and is not a future date.

If the SE Onset Date is not valid for a given SE, then the SE is assigned to the subject visit containing the Final Effective Visit Date. If the SE Onset Date is less than or equal to the earliest Effective Visit N Date for the subject, the SE will be assigned to the subject visit with the earliest Effective Visit N Date (e.g., Visit 1). If the SE Onset Date is greater than the Final Effective Visit Date for the subject, the SE will be assigned to the subject visit containing the Final Effective Visit Date. If the SE Onset Date falls between two contiguous Effective Visit N Dates for the subject, i.e., Effective Visit K Date<SE Onset Date≦Effective Visit L Date, where K<L and L≦the subject visit containing the Final Effective Visit Date for the subject, then the SE will be assigned to Visit L. This method can be termed “forward slotting,” since SEs are assigned forward to the next visit chronologically following the SE Onset Date.

In operation 360, the system calculates Site Visit N SE Count:

Site Visit N SE Count=Σ all SEs that have been slotted to Visit N for subjects at the site (6)

In operation 365, the system calculates Total Site SE Count, which is subsequently assessed against an Expected Total Site SE Count:

Total Site SE Count=Σ Site Visit N SE Count across all visits in the trial's expected visit calendar (7)

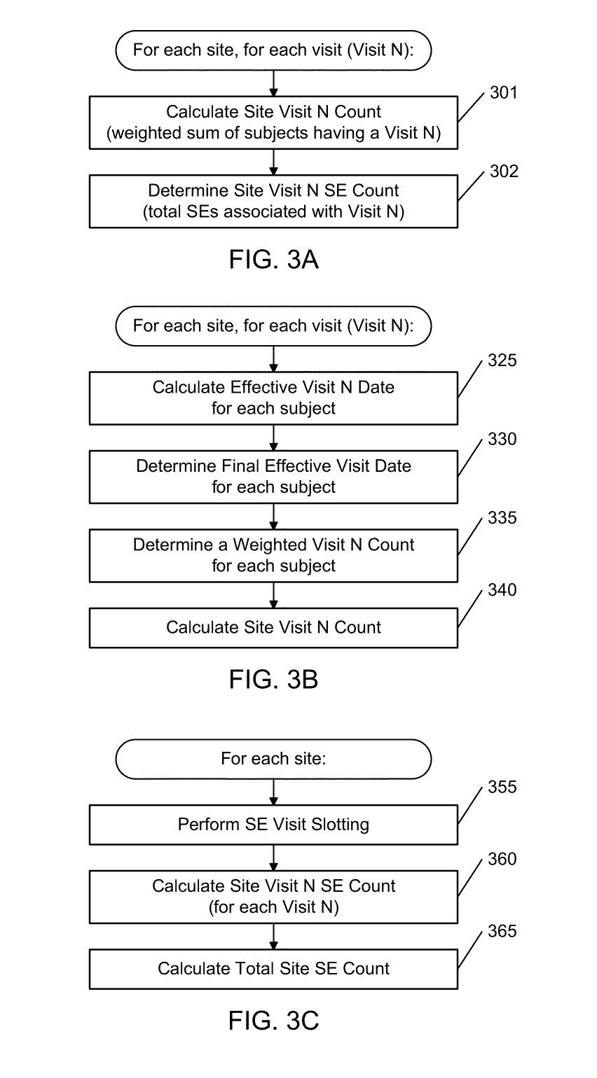

FIG. 4 illustrates another way of viewing the calculation of Site Visit N Count (operation 340), Site Visit N SE Count (operation 360), and Total Site SE Count (operation 365) using subject event and visit count processor 50. Three inputs may be used: the expected visit calendar 3 for subjects at the site, the reported subject visits 7, and the SEs 5 reported for subjects at the site. Expected visit calendar 3 and reported subject visits 7 are used in box 410 to calculate the Effective Visit N Dates and the Final Effective Visit Dates. Effective Visit N Dates and Final Effective Visit Dates are used in box 420 to calculate the Site Visit N Counts (e.g., Site Visit 1 Count, Site Visit 2 Count, etc., . . . Site Visit N Count).

Effective Visit N Dates, Final Effective Visit Dates, and reported SEs 5 are used in box 430 to calculate Site Visit N SE Counts (e.g., Site Visit 1 SE Count, Site Visit 2 SE Count, etc., . . . Site Visit N SE Count). All of the Site Visit N SE Counts are then summed in box 440 to generate Total Site SE Count 15.

### Trial SE Rates Per Visit

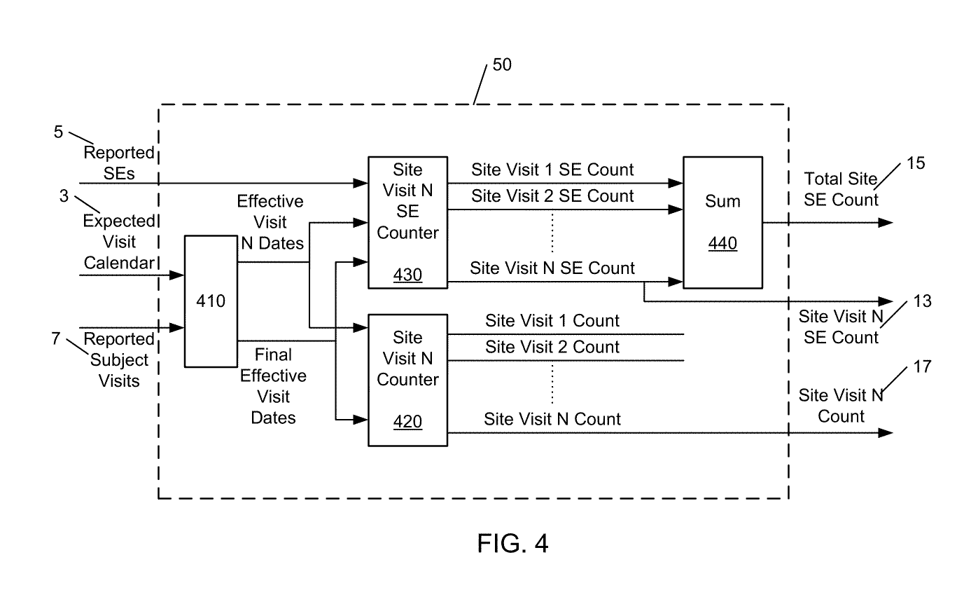

Once Site Visit N Count 17 (operation 340) and Site Visit N SE Count 13 have been calculated as shown in FIGS. 3A-3C and 4, a Trial Visit N SE Rate may be computed for each “Visit N” in the trial's expected visit calendar, as a direct rate across all sites in the trial. The steps for this process are shown in FIG. 5B, in which operation 560, calculating Trial Visit N SE Rate, is based on the results of operation 551, calculating Trial Visit N SE Count, and operation 552, calculating Trial Visit N Count. In particular, in operation 551:

Trial Visit N SE Count=Σ Site Visit N SE Count across all sites in the trial (8)

And in operation 552:

Trial Visit N Count=Σ Site Visit N Count across all sites in the trial (9)

Then, in operation 560:

$$Trial Visit N SE Rate = \frac{Trial Visit N SE Count}{Trial Visit N Count} \qquad ( 10 )$$

For the more general situation shown in FIG. 2A that calculates total site subject event count 14 and total site visit count 18, a Trial SE Rate may be computed across all sites in the trial. The steps for this process are shown in FIG. 5A, in which operation 510, calculating Trial SE Rate, is based on the results of operation 501, calculating Trial SE Count, and operation 502, calculating Trial Visit Count. In particular, in operation 501:

Trial SE Count=Σ Site SE Count across all sites in the trial (11)

And in operation 502:

Trial Visit Count=Σ Site Visit Count across all sites in the trial (12)

Then, in operation 510:

$$Trial SE Rate = \frac{Trial SE Count}{Trial Visit Count} \qquad ( 13 )$$

### Expected SE Counts Per Site

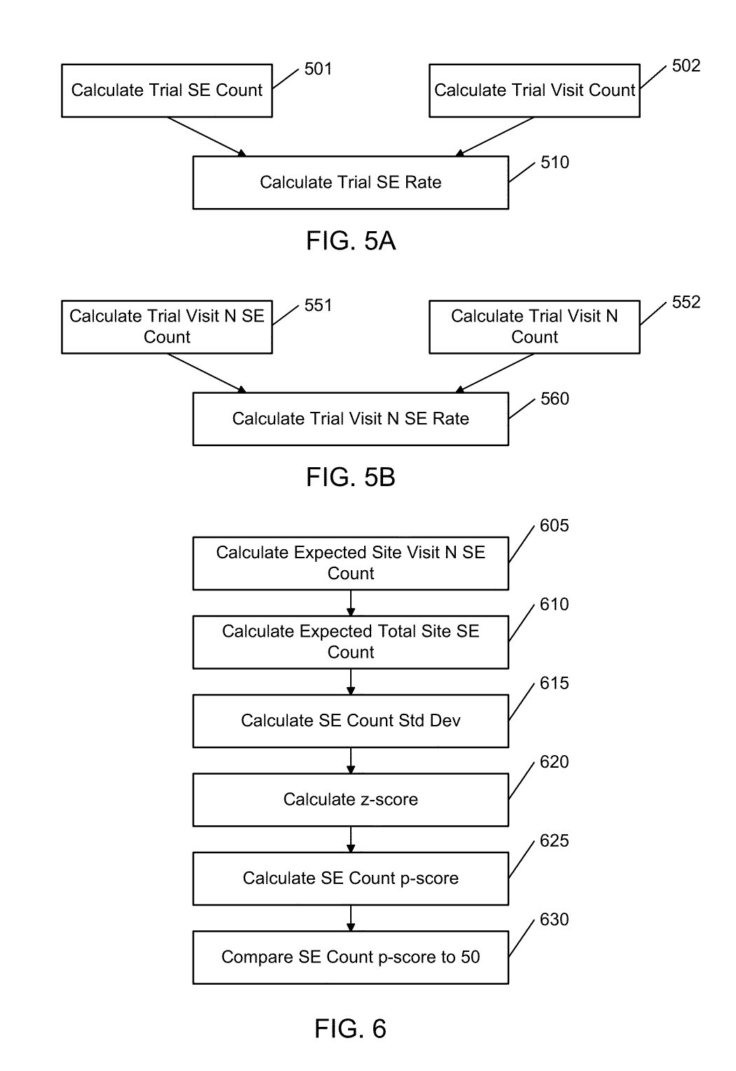

FIG. 6 is a flowchart showing how the SE reporting assessment is made for each site. In operation 605, an expected SE count is computed for each visit N at a given site based on the Trial Visit N SE Rate, which represents the benchmark expected rate for Visit N against which each site is evaluated:

Expected Site Visit N SE Count=(Trial Visit N SE Rate)*(Site Visit N Count). (14)

Then, in operation 610, the total expected count of SEs for the site is calculated:

Expected Total Site SE Count=Σ Expected Site Visit N SE Count across all visits in the trial's expected visit calendar. (15)

### Assessing Site SE Count Deviation from Expectation

Assessing the likelihood that a site is under- or over-reporting subject events may be accomplished by calculating the probability that the subject event count for the specific clinical trial site may naturally deviate from the expected subject event count by the amount observed. A Poisson distribution model may help assess each site's actual SE count against the expected SE count for the site. According to the Poisson model, the standard deviation of a given expected count lambda (λ) is the square root of lambda (\sqrt{λ}). Thus in operation 615, when lambda (λ) is represented by Expected Total Site SE Count,

SE Count Std Dev=\sqrt{Expected Total Site SE Count} (16)

In operation 620, a z-score (or z-value) representing the number of standard deviations by which the site's SE count differs from the expected count may be calculated:

$$z = \frac{Total Site SE Count - Expected Total SE Count}{SE Count Std Dev} \qquad ( 17 )$$

Assuming the Poisson model, the z-score may be approximated as coming from the normal distribution and the following formula may be used in calculating a directional p-score (operation 625):

SE Count p-Score=100*P(Z<z)=100*Φ(z) (18)

where φ(z) is the cumulative distribution function of a Normal distribution. For easier implementation (e.g., less computational power), the approximation of this function using elementary functions translates into the following formula:

$$SE Count p \text{-} Score = 100 * \frac{{e}^{{1.6}^{*} z + {0.07}^{*} {z}^{3}}}{1 + {e}^{{1.6}^{*} z + {0.07}^{*} {z}^{3}}} \qquad ( 19 )$$

where the 1.6 and 0.07 have been derived by the inventors. This score has a range of values from 0 to 100, where a value of 50 indicates that the site's total SE count matches the expected total SE count exactly (i.e., z=0); values higher than 50 indicate the site's SE count is higher than expected; and values lower than 50 indicate the site's SE count is lower than expected. This is why the p-score is called “directional.” Thus, in operation 630, a comparison is made between the SE Count p-score, and the closer that value gets to 0 or 100, the more unexpected the site's SE count becomes, and the more risky the site's SE reporting is and should be investigated.

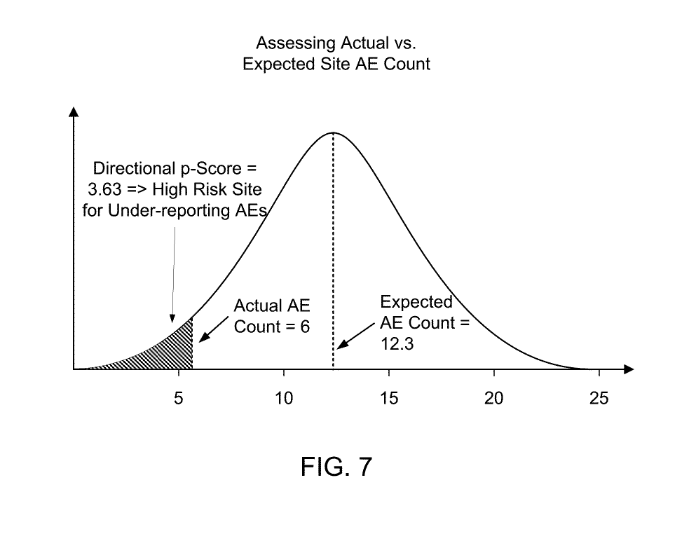

FIG. 7 provides an illustrative example of how a site's actual AE (or SE) count is assessed against its expected count using a Poisson probability distribution. In the example, the expected AE count for the given site has been calculated to be 12.3, which is represented by a vertical dashed line near the center of the Poisson distribution curve. The site's actual AE count is 6, which is also represented by a vertical dashed line closer to the left-most end of the Poisson distribution curve. The shaded area under the curve to the left of the site's actual AE count represents the area of probability that the site's AE count would randomly fall in a range≦6, which is also the p-score. In this example, the estimated area under the curve—or p-score—is equal to 3.63, which would likely put this site in an elevated or high risk category for under-reporting AEs (or SEs). For example, it may be reasonable to consider a site at elevated risk if its p-score is <5 or >95, and at high risk if its p-score is <2 or >98. A site would then be considered at low risk if its p-score fell between 5 and 95. Other thresholds for low, medium and high risk may also be considered.

Besides the operations shown in FIGS. 3A-3C, 5A-5B, and 6, other operations or series of operations are contemplated to generate site SE rate and/or to assess a site's SE rate against a trial benchmark. Subsidiary calculations or determinations may need to be made in order to carry out the operations shown in the flowcharts. Moreover, the actual orders of the operations in the flow diagrams are not intended to be limiting, and the operations may be performed in any practical order. For example, in FIG. 5A, operations 501 and 502 may be carried out independently, and in FIG. 5B, operations 551 and 552 may be carried out independently.

Similarly, the parts and blocks shown in FIGS. 2A, 2B, and 4 are examples of parts that may comprise systems 100, 150, subject event and visit count processors 10, 50, and site subject event rate assessors 30, 60, and do not limit the parts or modules that may be included in or connected to or associated with these systems, subject event and visit count processors, and site subject event rate assessors. For example, the calculations in FIG. 4 show blocks only for Subject Visits 1, 2, and N, with an ellipsis for other visits. And the boxes in FIG. 4 may involve other operations not shown.

One benefit of the present invention is that adverse event reporting is based on more relevant and accurate measures of what is happening at sites, based on the age of each site (that is, how long it has been operating in the current trial), and length of time the subjects at each site have been participating in the trial. A key further refinement of the present invention is the recognition that subject participation time itself is best represented by the individual and distinct trial visits that have been reported for each subject, since expected AE reporting rates vary by subject visit. These factors provide a much more reliable way of comparing each site against other sites in the same trial which have been operating for different lengths of time.

The present invention differs from other systems that track AE rate or AE reporting compliance. For example, those systems do not take into account the variability in site age and cadence of subject visits, looking instead at overall rate of AEs per site or per subject.

Aspects of the present invention may be embodied in the form of a system, a computer program product, or a method. Similarly, aspects of the present invention may be embodied as hardware, software or a combination of both. Aspects of the present invention may be embodied as a computer program product saved on one or more computer-readable media in the form of computer-readable program code embodied thereon.

For example, the computer-readable medium may be a computer-readable signal medium or a computer-readable storage medium. A computer-readable storage medium may be, for example, an electronic, optical, magnetic, electromagnetic, infrared, or semiconductor system, apparatus, or device, or any combination thereof.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Computer program code in embodiments of the present invention may be written in any suitable programming language. The program code may execute on a single computer, or on a plurality of computers. The computer may include a processing unit in communication with a computer-usable medium, wherein the computer-usable medium contains a set of instructions, and wherein the processing unit is designed to carry out the set of instructions.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system for assessing a clinical trial site's subject event reporting rate, comprising:
a subject event and visit count processor for receiving subject event and subject visit data from a plurality of clinical trial sites, and calculating for each clinical trial site a total visit count and a total subject event count; and
a site subject event rate processor for:
receiving the total visit count and total subject event count for each clinical trial site;
calculating a trial-level subject event rate for the clinical trial;
calculating for each clinical trial site an expected total subject event count based on the clinical trial site's total visit count and the trial-level subject event rate; and
comparing for each clinical trial site the expected total subject event count to the total subject event count to assess the probability that the clinical trial site is under-reporting or over-reporting subject events.

2. The system of claim 1, wherein the calculating a trial-level subject event rate for the clinical trial comprises dividing the sum of the total subject event counts for all sites by the sum of the total visit counts for all sites.

3. The system of claim 1, wherein the calculating an expected total subject event count for each clinical trial site comprises multiplying the site's total visit count by the trial-level subject event rate.

4. The system of claim 1, wherein the total visit count for each clinical trial site is calculated as a weighted count by:
receiving subject visit data from a plurality of clinical trial sites; and
calculating for each clinical trial site and for each reported visit a weighted visit count, wherein the weighted count contribution represents an estimated proportion of all required visit data that have been already reported for the subject for the given reported visit.

5. The system of claim 4, wherein the weighted count contribution is a value between 0 and 1.

6. The system of claim 1, wherein the comparing comprises calculating the probability that the subject event count for each clinical trial site differs from the expected subject event count.

7. The system of claim 6, wherein the probability is calculated using a p-score.

8. A system for assessing a clinical trial site's subject event reporting rate, comprising:
a subject event and visit count processor for:
receiving subject event and subject visit data from a plurality of clinical trial sites;
receiving an expected visit calendar identifying distinct visits for the clinical trial; and
calculating for each clinical trial site:
a subject count and a subject event count associated with each distinct visit; and
a total subject event count for all subjects and all distinct visits; and
a site subject event rate processor for:
receiving the subject count and subject event count associated with each distinct visit;
receiving the total subject event count;
calculating for each distinct visit a trial-level subject event rate;
calculating for each clinical trial site:
an expected subject event count for each distinct visit, using the trial-level subject event rate for the same distinct visit; and
an expected total subject event count as the sum of the expected subject event counts for each distinct visit; and
comparing for each clinical trial site the expected total subject event count to the total subject event count for the clinical trial site to assess the probability that the clinical trial site is under-reporting or over-reporting subject events.

9. The system of claim 8, wherein the calculating a trial-level subject event rate for each distinct visit comprises dividing the trial subject event count for each distinct visit by the trial visit count for each distinct visit.

10. The system of claim 8, wherein the subject count for each clinical trial site for each distinct visit is calculated as a weighted count by:
receiving subject visit data from a plurality of clinical trial sites;
receiving an expected visit calendar identifying distinct visits; and
calculating for each clinical trial site and for each distinct visit a weighted subject count, wherein the weighted count contribution for each subject represents an estimated proportion of all required visit data that have already been reported for the subject for the given distinct visit.

11. The system of claim 10, wherein the weighted count contribution is a value between 0 and 1.

12. The system of claim 8, wherein each subject event at each clinical trial site is associated with a distinct visit using a temporal association method, the method comprising:
receiving subject visit data and subject event data from a plurality of clinical trial sites;
receiving an expected visit calendar identifying distinct visits; and
calculating for each clinical trial site and for each distinct visit a subject event count, wherein the contribution for each subject event is counted if the subject event has a date value that is temporally associated with the subject visit date for the given distinct visit selected from one of the following:
the subject event date is less than or within a specified number of days following the subject visit date, and this is the earliest visit date for the subject; or
the subject event date is less than or within a specified number of days following the subject visit date, and is at least a specified number of days following the most recent preceding subject visit date for the subject; or
the subject event date is within a specified number of days following the subject visit date, and this is the most recent visit date for the subject;
and not counted otherwise.

13. The system of claim 8, wherein the comparing comprises calculating the probability that the subject event count for each clinical trial site differs from the expected subject event count.

14. The system of claim 13, wherein the probability is calculated using a p-score.

15. A method for assessing a clinical trial site's subject event reporting rate, comprising:
receiving subject event and subject visit data from a plurality of clinical trial sites;
calculating for each clinical trial site a visit count and a subject event count based on the subject event and subject visit data for each distinct visit in an expected visit calendar;
calculating a subject event rate for the plurality of clinical trial sites based on the visit count and subject event count for each clinical trial site;
calculating for each clinical trial site an expected subject event count based on the visit count for each clinical trial site;
calculating a total expected subject event count for each clinical trial site based on the sum of the expected subject event counts for each distinct visit; and
comparing the subject event count for the clinical trial site to the expected subject event count to determine whether the clinical trial site is under-reporting or over-reporting subject events.

16. The method of claim 15, wherein the comparing comprises calculating the probability that the subject event count for each clinical trial site differs from the expected subject event count.

17. The method of claim 16, wherein the probability is calculated using a p-score.

18. A method for determining a subject event rate for a clinical trial, comprising:
receiving subject event and subject visit data from a plurality of sites of the clinical trial;
receiving an expected visit calendar for the clinical trial;
calculating for each clinical trial site a subject visit count and a subject event count based on the subject event and subject visit data; and
calculating the subject event rate for the clinical trial as a function of the subject event count, the subject visit count, and the expected visit calendar.

19. The method of claim 18, wherein the subject event rate for the clinical trial is used to assess the probability that a clinical trial site is under-reporting or over-reporting subject events.
